(19) United States
(12) Patent Application Publication
(10) Pub. No.: US 2025/0106297 A1
(43) Pub. Date: Mar. 27, 2025

(54) METHOD AND APPARATUS FOR SUPPORTING EDGE APPLICATION SERVER DISCOVERY AND SELECTION IN MOBILE EDGE COMPUTING SYSTEM

(71) Applicant: SAMSUNG ELECTRONICS CO., LTD., Suwon-si (KR)

(72) Inventor: Hyesung KIM, Suwon-si (KR)

(21) Appl. No.: 18/898,400

(22) Filed: Sep. 26, 2024

(30) Foreign Application Priority Data
Sep. 26, 2023 (KR) 10-2023-0129186

(51) Int. Cl. H04L 67/51; H04L 41/083; H04L 67/60; H04W 4/50

(52) U.S. Cl. CPC H04L 67/51; H04L 41/083; H04L 67/60; H04W 4/50

(57) ABSTRACT

The disclosure relates to a 5G or 6G communication system for supporting a higher data transmission rate. According to an embodiment, a method by an edge enabler server (EES) in a mobile edge computing system comprises transmitting, to an edge configuration server (ECS), a request message for storing common edge application server (EAS) bundle information. In an embodiment, the request message includes the common EAS bundle information and the common EAS bundle information includes at least one of EAS bundle identifier (ID) of an EAS bundle, a list of EAS ID in the EAS bundle and main EAS ID in the EAS bundle.

### CROSS-REFERENCE TO RELATED APPLICATION

This application is based on and claims priority under 35 U.S.C. § 119 to Korean Patent Application No. 10-2023-0129186, which was filed in the Korean Intellectual Property Office on Sep. 26, 2023, the entire disclosure of which is incorporated herein by reference.

### BACKGROUND

### 1. Field

The disclosure relates to a mobile communication system and an edge computing system and, more specifically, to a method and apparatus for supporting edge application discovery and selection through a mobile edge computing system.

### 2. Description of Related Art

5th generation (5G) mobile communication technology defines a wide frequency band to enable fast transmission speed and new services and may be implemented in frequencies below 6 GHz (“sub 6 GHz”), such as 3.5 GHz, as well as in ultra-high frequency bands (“above 6 GHz”), such as 28 GHz and 39 GHz called millimeter wave (mmWave). Further, 6G mobile communication technology, which is called a beyond 5G system, is considered to be implemented in terahertz bands (e.g., 95 GHz to 3 THz) to achieve a transmission speed 50 times faster than 5G mobile communication technology and ultra-low latency reduced by 1/10.

In the early stage of 5G mobile communication technology, standardization was conducted on beamforming and massive MIMO for mitigating propagation pathloss and increasing propagation distance in ultrahigh frequency bands, support for various numerologies for efficient use of ultrahigh frequency resources (e.g., operation of multiple subcarrier gaps), dynamic operation of slot format, initial access technology for supporting multi-beam transmission and broadband, definition and operation of bandwidth part (BWP), new channel coding, such as low density parity check (LDPC) code for massive data transmission and polar code for high-reliable transmission of control information, L2 pre-processing, and network slicing for providing a dedicated network specified for a specific service, so as to meet performance requirements and support services for enhanced mobile broadband (eMBB), ultra-reliable low-latency communications (URLLC), and massive machine-type communications (mMTC).

Currently, improvement and performance enhancement in the initial 5G mobile communication technology is being discussed considering the services that 5G mobile communication technology has intended to support, and physical layer standardization is underway for technology, such as vehicle-to-everything (V2X) for increasing user convenience and assisting autonomous vehicles in driving decisions based on the position and state information transmitted from the VoNR, new radio unlicensed (NR-U) aiming at the system operation matching various regulatory requirements, NR UE power saving, non-terrestrial network (NTN) which is direct communication between UE and satellite to secure coverage in areas where communications with a terrestrial network is impossible, and positioning technology.

Also being standardized are radio interface architecture/protocols for technology of industrial Internet of things (IIoT) for supporting new services through association and fusion with other industries, integrated access and backhaul (IAB) for providing nodes for extending the network service area by supporting an access link with the radio backhaul link, mobility enhancement including conditional handover and dual active protocol stack (DAPS) handover, 2-step random access (RACH for NR) to simplify the random access process, as well as system architecture/service fields for 5G baseline architecture (e.g., service based architecture or service based interface) for combining network functions virtualization (NFV) and software-defined networking (SDN) technology and mobile edge computing (MEC) for receiving services based on the position of the UE.

As 5G mobile communication systems are commercialized, soaring connected devices would be connected to communication networks so that reinforcement of the function and performance of the 5G mobile communication system and integrated operation of connected devices are expected to be needed. To that end, new research is to be conducted on, e.g., extended reality (XR) for efficiently supporting, e.g., augmented reality (AR), virtual reality (VR), and mixed reality (MR), and 5G performance enhancement and complexity reduction using artificial intelligence (AI) and machine learning (ML), support for AI services, support for metaverse services, and drone communications.

Further, development of such 5G mobile communication systems may be a basis for multi-antenna transmission technology, such as new waveform for ensuring coverage in 6G mobile communication terahertz bands, full dimensional MIMO (FD-MIMO), array antenna, and large scale antenna, full duplex technology for enhancing the system network and frequency efficiency of 6G mobile communication technology as well as reconfigurable intelligent surface (RIS), high-dimensional space multiplexing using orbital angular momentum (OAM), metamaterial-based lens and antennas to enhance the coverage of terahertz band signals, AI-based communication technology for realizing system optimization by embedding end-to-end AI supporting function and using satellite and artificial intelligence (AI) from the step of design, and next-generation distributed computing technology for implementing services with complexity beyond the limit of the UE operation capability by way of ultrahigh performance communication and computing resources.

### SUMMARY

The disclosure provides a method and apparatus for supporting edge application server discovery and selection through a mobile edge computing system.

The disclosure provides a method and apparatus for efficiently performing interworking with a mobile communication core network related to a corresponding edge application server.

In the disclosure, a service provided to one application client may be provided through interworking between multiple EASs (e.g., EAS bundle). There is provided a method and apparatus for leading users of using a service to receive a service from the same EASs when multiple users interwork with each other while using a service.

According to an embodiment, a method by an edge enabler server (EES) in a mobile edge computing system comprises transmitting, to an edge configuration server (ECS), a request message for storing common edge application server (EAS) bundle information. In an embodiment, the request message includes the common EAS bundle information and the common EAS bundle information includes at least one of EAS bundle identifier (ID) of an EAS bundle, a list of EAS ID in the EAS bundle and main EAS ID in the EAS bundle.

According to an embodiment, a method by an edge configuration server (ECS) in a mobile edge computing system comprises receiving, from an edge enabler server (EES), a request message for storing common edge application server (EAS) bundle information; and storing the common EAS bundle information. In an embodiment, the request message includes the common EAS bundle information, and the common EAS bundle information includes at least one of EAS bundle identifier (ID) of an EAS bundle, a list of EAS ID in the EAS bundle and main EAS ID in the EAS bundle.

According to an embodiment, an edge enabler server (EES) in a mobile edge computing system comprises a transceiver; and at least one processor coupled to the transceiver and configured to transmit, to an edge configuration server (ECS), a request message for storing common edge application server (EAS) bundle information. In an embodiment, the request message includes the common EAS bundle information and the common EAS bundle information includes at least one of EAS bundle identifier (ID) of an EAS bundle, a list of EAS ID in the EAS bundle and main EAS ID in the EAS bundle.

According to an embodiment, an edge configuration server (ECS) in a mobile edge computing system comprises a transceiver; and at least one processor coupled to the transceiver and configured to receive, from a first edge enabler server (EES), a request message for storing common edge application server (EAS) bundle information, and store the common EAS bundle information. In an embodiment, the request message includes the common EAS bundle information, the common EAS bundle information includes at least one of EAS bundle identifier (ID) of an EAS bundle, a list of EAS ID in the EAS bundle and main EAS ID in the EAS bundle.

The disclosure may support discovery and selection of an EAS bundle including a plurality of EASs for a given user group. This may lead the service provided to users receiving the same service to be provided from the same EAS bundle, reducing unnecessary interworking between servers and enhancing service quality.

The disclosure may also efficiently perform interworking with a mobile communication core network related to a corresponding edge application server.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

A more complete appreciation of the disclosure and many of the attendant aspects thereof will be readily obtained as the same becomes better understood by reference to the following detailed description when considered in connection with the accompanying drawings, wherein:

FIG. 1 illustrates an edge computing system structure and a core network interworking structure according to an embodiment of the present disclosure;

FIG. 2 illustrates a procedure of discovering and selecting a common EAS bundle using ECS according to an embodiment of the present disclosure;

FIG. 3 illustrates a procedure of discovering and selecting a common EAS bundle according to an embodiment of the present disclosure;

FIG. 4 illustrates an AF request procedure for a common EAS according to an embodiment of the present disclosure;

FIG. 5 illustrates an AF request procedure for a common EAS according to an embodiment of the present disclosure; and

FIG. 6 illustrates a structure of a network entity according to an embodiment of the present disclosure.

### DETAILED DESCRIPTION

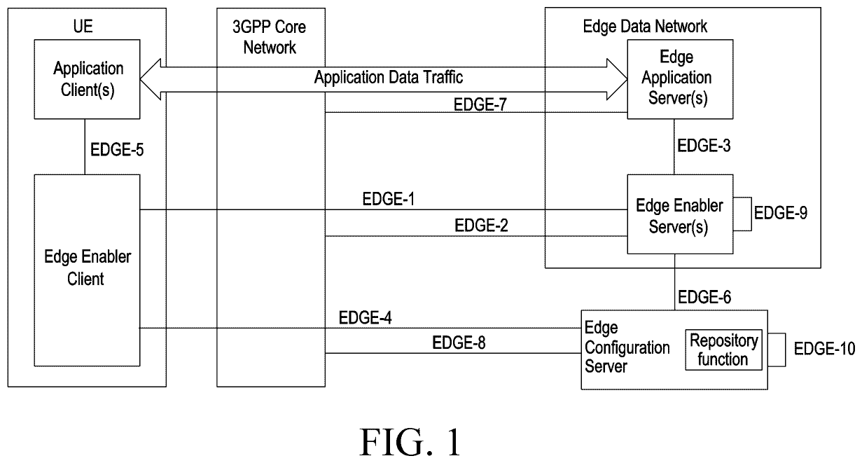

FIGS. 1 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, the operational principle of the disclosure is described below with reference to the accompanying drawings. The terms described below are ones defined considering functions in the disclosure. Since the terms may be varied according to the user's or operator's intent or custom, their definitions should be determined according to the contents throughout the disclosure.

For the same reasons, some elements may be exaggerated or schematically shown. The size of each element does not necessarily reflect the real size of the element. The same reference numeral is used to refer to the same element throughout the drawings.

Hereinafter, a base station (BS) is an entity that performs resource allocation of a UE, and may be at least one of a gNode B, eNode B, Node B, (or xNode B (where x is an alphabetic character including g and e)), a radio access unit, a base station controller, a satellite, an airborne, or a node on network. The user equipment (UE) may include a mobile station (MS), vehicle, satellite, airborne, cellular phone, smartphone, computer, or multimedia system capable of performing communication functions. In the disclosure, downlink (DL) refers to a wireless transmission path of signal transmitted from the base station to the terminal, and uplink (UL) refers to a wireless transmission path of signal transmitted from the terminal to the base station. Additionally, a sidelink (SL) meaning a radio transmission path of a signal transmitted from a UE to another UE may exist.

Although LTE, LTE-A, or 5G systems may be described below as an example, the embodiments may be applied to other communication systems having a similar technical background or channel pattern. For example, embodiment may also encompass 5G-advance or NR-advance or 6th generation mobile communication technology (6G) developed after 5G mobile communication technology (or new radio, NR). The following 5G may be a concept encompassing the legacy LTE, LTE-A, and other similar services. Further, the embodiments may be modified in such a range as not to significantly depart from the scope of the disclosure under the determination by one of ordinary skill in the art and such modifications may be applicable to other communication systems.

It should be appreciated that the blocks in each flowchart and combinations of the flowcharts may be performed by computer program instructions. Since the computer program instructions may be equipped in a processor of a general-use computer, a special-use computer or other programmable data processing devices, the instructions executed through a processor of a computer or other programmable data processing devices generate means for performing the functions described in connection with a block(s) of each flowchart. Since the computer program instructions may be stored in a computer-available or computer-readable memory that may be oriented to a computer or other programmable data processing devices to implement a function in a specified manner, the instructions stored in the computer-available or computer-readable memory may produce a product including an instruction means for performing the functions described in connection with a block(s) in each flowchart. Since the computer program instructions may be equipped in a computer or other programmable data processing devices, instructions that generate a process executed by a computer as a series of operational steps are performed over the computer or other programmable data processing devices and operate the computer or other programmable data processing devices may provide steps for executing the functions described in connection with a block(s) in each flowchart.

Further, each block may represent a module, segment, or part of a code including one or more executable instructions for executing a specified logical function(s). Further, it should also be noted that in some replacement embodiments, the functions mentioned in the blocks may occur in different orders. For example, two blocks that are consecutively shown may be performed substantially simultaneously or in a reverse order depending on corresponding functions.

As used herein, the term “unit” means a software element or a hardware element such as a field-programmable gate array (FPGA) or an application specific integrated circuit (ASIC). A unit plays a certain role. However, “unit” is not limited to software or hardware. A “unit” may be configured in a storage medium that may be addressed or may be configured to execute one or more processors. Accordingly, as an example, a “unit” includes elements, such as software elements, object-oriented software elements, class elements, and task elements, processes, functions, attributes, procedures, subroutines, segments of program codes, drivers, firmware, microcodes, circuits, data, databases, data architectures, tables, arrays, and variables. Functions provided within the components and the “units” may be combined into smaller numbers of components and “units” or further separated into additional components and “units.” Further, the components and “units” may be implemented to execute one or more CPUs in a device or secure multimedia card. According to embodiments, a “ . . . unit” may include one or more processors.

The 3GPP, which is in charge of cellular mobile communication standardization, has named the new core network structure 5G core (5GC) and standardized the same to promote the evolution from the 4G LTE system to the 5G system. 5GC supports the following differentiated functions as compared to the evolved packet core (EPC), which is the network core for 4G.

The terms referring to network entities and objects of an edge computing system as used herein, the terms referring to messages, and the term referring to identification information are provided as an example for ease of description. Thus, the disclosure is not limited by the terms, and such terms may be replaced with other terms denoting objects with equivalent technical concept.

Although terms and names as defined in the 5G system standard are used herein for ease of description, embodiment are not limited thereto or thereby, and the same may apply likewise to systems conforming to other standards.

The disclosure deals with a method for leading to access the same EAS for a user group receiving one service in an edge computing system. Specifically, the disclosure deals with a method for leading a corresponding user group to receive a service from the same EAS bundle when a corresponding service is provided through an EAS bundle including a plurality of EASs.

FIG. 1 illustrates an edge computing system structure and a core network interworking structure according to an embodiment of the present disclosure.

The edge computing system may include an edge enabler server (EES), an edge configuration server (ECS), and an edge enabler client (EEC). The edge enabler server (EES) is establishing an edge hosting environment (or edge computing platform) and knows information about the edge application server (EAS) running in the edge hosting environment.

The edge enabler server negotiates with the UE to connect the application client of the UE with the edge application server (EAS) in the edge hosting environment. The UE supporting the edge computing system may embed the edge enabler client (EEC), and the negotiation may proceed through interworking between the edge enabler client (EEC) and the edge enabler server (EES). The layer where interworking between the edge enabler client and the edge enabler is performed such as the above-described negotiation may be referred to as an edge enabling layer. The UE mentioned in the disclosure may include an IoT device and a vehicle, as well as a smartphone.

The edge configuration server (ECS) may know deployment information about the edge enabler servers (EESs) and perform a function of transferring configuration information for using the edge computing service to the UE. The configuration information may include, e.g., edge data network connection information (e.g., data network name (DNN), single-network slice selection assistance (S-NSSAI), etc.), edge data network service area information (e.g., a cell list, a list of tracking area, a public land mobile network (PLMN) identifier (ID), edge enabler server connection information (e.g., uniform resource identity (URI)), etc. The edge data network service area may be an edge enabler server (EES) available area set by the edge enabler server (EES). Based on this, the UE may receive information about the edge enabler server (EES) accessible at a specific location. If the edge data network configuration server may know information about the edge application server (EAS) running in the edge hosting environment of the specific edge enabler server (EES), the UE may also obtain the corresponding information through the edge enabler client (EE). The edge configuration server (EAS) may support the repository function according to the implementation to store and manage information related to another edge configuration server (ECS) or the edge application server (EAS).

The edge application server (EAS) refers to a third party application server driven in the edge computing system. It is a third party application server driven on the infrastructure provided by the edge hosting environment and is able to provide a service at a position close to the UE, and thus, it may provide an ultra-low latency service.

In the UE, there may be an application client, an edge enabler client (EEC) for interworking the application client with the edge computing service, and a mobile terminal (MT) accessing the mobile communication system. The application of the UE is an application provided by a third party and refers to a client application program driven in the UE for a specific application service. Several applications may be driven in the UE. At least one of the applications may use multi-access edge computing (MEC) services.

The edge enabler client (EEC) in the UE refers to a client that performs an operation in the UE necessary for using the edge computing service. The operations for determining which application may use the edge computing service, and connecting the network interface so that data of the UE application client may be transferred to the edge application server (EAS) providing the edge computing service may be performed. The operation for establishing a data connection for using the edge computing service may be performed by the 3GPP communication layer through the mobile terminal. The 3GPP communication layer refers to a layer that performs a modem operation for using a mobile communication system and serves to establish a wireless connection for data communication, register the UE in the mobile communication system, establish a connection for data transmission in the mobile communication system, and transmit and receive data.

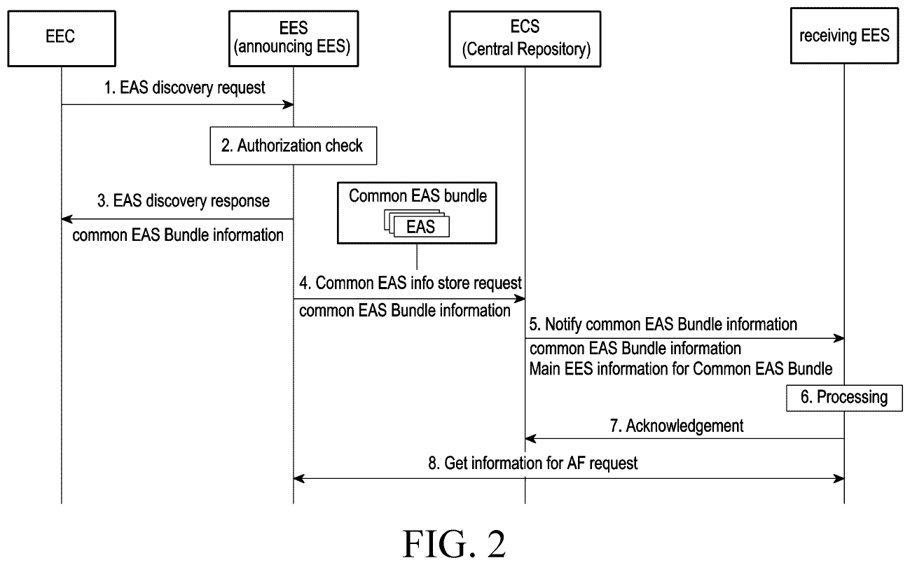

FIG. 2 illustrates a procedure of discovering and selecting a common EAS bundle using an edge computing server (ECS) according to an embodiment of the present disclosure.

Referring to FIG. 2, a procedure of discovering and selecting a common EAS bundle may be performed between an EEC, an announcing EES, an ECS, a receiving EES, and an ECS, and in the disclosure, the announcing EES may be referred to as a first EES, and the receiving EES may be referred to as a second EES.

Before performing step 1, the EEC may transmit, to the ECS, a service provisioning request including at least one of an AC profile (information such as an AC identifier, an AC type, a preferred edge computing service provider (ECSP) list, an EAS ID, an AC service continuity support), an application group profile (application group ID, EAS ID, expected group geographical service area), and common EAS bundle information (information including multiple pieces of EAS information, a bundle type, a common bundle ID, a main EAS ID, or common EAS bundle requirements) and may receive, from the ECS, information about the EES where the EAS bundle (multiple EASs) constituting the common EAS bundle is registered. According to an embodiment, the common EAS bundle information may be included and provided in an AC profile or an application group profile. For example, when the application group profile and the common EAS bundle information are included in the request message received from the EEC, the ECS may select an EES and an EDN in which EAS which may be selected as the common EAS bundle are registered and managed using the corresponding application group profile and UE location information. The ECS may select multiple EESs and EDNs for the received common EAS bundle information. The EEC may transmit an EAS discovery request using the EES information received from the ECS as follows.

In step 1, the EEC may transmit the EAS discovery request message to the EES (hereinafter, referred to as an “announcing EES”). The corresponding EAS discovery request may include at least one of the EEC ID, the UE ID, the AC profile, the application group profile (application group ID, EAS ID, expected group service area), common EAS bundle information, or UE location information. The EAS discovery request may include common EAS bundle information. The common EAS bundle information may include at least one of the plurality of pieces of EAS information, the bundle type, the common bundle ID, the main EAS ID, common EAS bundle requirements, or the like. The common EAS bundle information may mean that the same EAS bundle as other UEs (e.g., UEs identifiable by the application group profile, a UE group IE, or a UE ID list) may be selected for the EAS bundle identified by given information.

According to an embodiment, the common EAS bundle information may be included in the AC profile, may be included in the application group profile information, or may be included in the EAS bundle requirement to be provided to the announcing EES. For example, as shown in Table 1 below, the common EAS bundle information may be added to the application group profile and provided to the EES by the EEC.

TABLE 1

| Information element | Status | Description |
|---|---|---|
| Application | M | Uniquely identifies a group of UEs using |
| Group ID | | the same application as defined in 7.2.11 |
| EAS ID | M | Identifier of EAS |
| Expected Group | O | The expected location(s) (e.g., route) of the |
| Geographical | | group of UEs during the AC's operation |
| Service Area. | | schedule. This geographic information can |
| | | express a geographic point, polygon, |
| | | route, signaling map, or waypoint set. |
| List of common | O | List of EAS bundles, which require to be |
| EAS bundle | | commonly selected for a group of UE, to |
| information | | which the EAS belongs and |
| | | related bundling requirements. |
| Bundle ID | M | Bundle ID as described |
| Bundle type | M | Type of the EAS bundle |
| EAS bundle | O | Requirements associated with the EAS |
| requirements | | bundle |
| Main EAS ID | O | Indicate which EAS in a bundle takes the |
| | | main EAS service role. |
| list of EAS ID | O | List of EAS ID to be invoked by the EAS |
| | | for EAS driven associated EAS. |

### Application Group Profile Including Common EAS Bundle Information

Further, as shown in Table 2, common EAS bundle-related information may be included in the EAS bundle requirement and be provided to the announcing EES.

TABLE 2

| Information | | |
|---|---|---|
| element | Status | Description |
| Coordinated | O | Indicates if coordinated EAS discovery is required |
| EAS | | i.e., if EAS discovery request for one of the |
| discovery | | bundled EAS is processed, then EAS discovery |
| | | response may include information of all the EASs |
| | | belonging to the bundle. |
| Coordinated | O | Indicates if coordinated accounting request (ACR) |
| ACR | | is required i.e., if EAS ACR is initiated for one of |
| | | the bundled EAS, then ACR may be initiated for |
| | | all the EASs belonging to the bundle. |
| | | The IE may further indicate what actions may be |
| | | taken if ACR for one or more bundled EAS fails |
| | | e.g., ACR for all other EAS that are part of the |
| | | bundle may be cancelled or not. |
| Affinity | O | Indicates the affinity requirement of the EAS |
| | | bundle. The IE can be set to ″strong″ indicating |
| | | that the EASs may be in the same EDN, |
| | | ″preferred″ indicating that it is nice to have EASs |
| | | in the same EDN but not essential or ″weak″ |
| | | indicating that it is not essential for EASs to be |
| | | in the same EDN. |
| List of | O | Indicates if the selection of Common EAS bundle |
| common | | is required for a group of UE, to which the EAS |
| EAS bundle | | belongs and related bundling requirements. |
| information | | Bundle ID, Bundle type, Main EAS ID, list |
| | | of EAS ID |

### EAS Bundle Requirements

In step 2, the announcing EES performs an authorization operation for the EAS discovery request of the EEC. It may be identified whether common EAS bundle discovery and selection is allowed for the corresponding UE or EEC.

In step 3, the announcing EES, after performing successful authorization, may determine the common EAS bundle considering the AC profile, UE location, common EAS bundle information, and EAS profile (information received from the EAS) and may provide the corresponding information to the EEC through an EAS discovery response message. The information about the common EAS bundle determined by the announcing EES and provided to the EEC may include at least one of a plurality of EAS profile lists (each EAS profile includes EAS address information), information indicating that the corresponding EAS are a bundle, an EAS bundle requirement, or main EAS information about the selected common EAS bundle.

In step 4, the announcing EES may transmit a request for storing the corresponding common EAS bundle information to the ECS supporting the central repository function. The information provided by the announcing EES to the ECS may include an EAS ID, EAS address information, a common bundle ID, a common bundle type, a UE group ID, a UE ID list, an application group profile, and EES information in which the EASs constituting the common EAS bundle are registered (the EES in which the main EAS is registered may be indicated as the main EES, and may include address and identifier information about the main EES) and EDN information (DNAI or DNN information). The announcing EES may know information about whether the central repository is supported through previously configured information or may know a response to the EES registration request to the ECS from the ECS. The ECS according to an embodiment may provide central repository-related function information supported by the ECS when providing the EES registration response information to the announcing EES.

According to an embodiment, the ECS may configure the EES information requesting to store the common EAS bundle information as the common EAS bundle announcing EES (or EES information storing the common EAS bundle information) and store the same together, corresponding to the common EAS bundle information.

According to an embodiment, the announcing EES may store AF request information related to the common EAS bundle in the ECS, and the corresponding information may include at least one of traffic correlation indication, EAS correlation indication for UEs accessing common EAS bundle, N6 information for common EAS bundle, AF request executed indication (an indicator indicating that AF request has already been performed), and DNAI, DNN, S- or NSSAI information about the common EAS bundle.

In step 5, the ECS may store the common EAS bundle-related information received from the EES and provide the common EAS bundle-related information to an EES (hereinafter, referred to as receiving EES) capable of utilizing the corresponding common EAS bundle information. According to an embodiment, the ECS may transmit a notification of the common EAS bundle information to the receiving EES that has previously sent a request to subscribe to the common EAS bundle information. The receiving EES may transmit a common EAS bundle information subscribe request message to the ECS in advance. The common EAS bundle information subscribe request message may include an EAS profile, a UE ID, EDN information, or the like. The corresponding notification message may include at least one of common EAS bundle information, a notification event ID, an EAS ID, EAS address information, a common bundle ID, a common bundle type, a UE group ID, a UE ID list, an application group profile, and EES information in which the EASs constituting the common EAS bundle are registered (the EES in which the main EAS is registered may be indicated as the main EES, and may include address and identifier information about the main EES) and EDN information, and common EAS bundle announcing EES (or EES information storing common EAS bundle information). According to an embodiment, the ECS may transmit a notification message for common EAS bundle information including AF request information related to the common EAS bundle to the receiving EES.

In step 6, the receiving EES receiving the common EAS bundle information notification from the ECS may store the corresponding information, and when a request related to the common EAS bundle discovery is received, may provide the information about the EAS bundle in the common EAS bundle information to the second EEC capable of utilizing the corresponding common EAS bundle information. According to an embodiment, the receiving EES may transmit a notification of the common EAS bundle information to the EEC that has previously sent a request to subscribe to the common EAS bundle information.

In step 7, the receiving EES may transmit an acknowledgement for the notification to the ECS.

In step 8, the receiving EES may request the announcing EES for AF request-related information for the common EAS bundle and obtain it. The AF request information related to the common EAS bundle may include at least one of traffic correlation indication, EAS correlation indication for UEs accessing common EAS bundle, N6 information for common EAS bundle, AF request executed indication (an indicator indicating that the AF request has already been performed), and DNAI, DNN, or S-NSSAI information for the common EAS bundle.

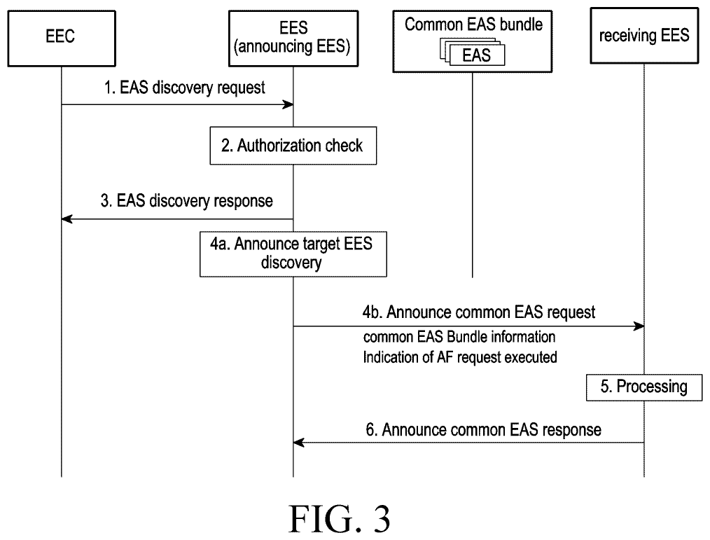

FIG. 3 illustrates a procedure of discovering and selecting a common EAS bundle according to an embodiment of the present disclosure.

Referring to FIG. 3, a procedure of discovering and selecting a common EAS bundle may be performed between an EEC, an announcing EES, an ECS, and a receiving EES. In the disclosure, the announcing EES may be referred to as a first EES, and the receiving EES may be referred to as a second EES.

Before performing step 1, the EEC may transmit, to the ECS, a service provisioning request including at least one of an AC profile (information such as AC identifier, an AC type, a preferred edge computing service provider (ECSP) list, an EAS ID, an AC service continuity support), an application group profile (application group ID, EAS ID, expected group geographical service area), and common EAS bundle information (information including multiple pieces of EAS information, a bundle type, a common bundle ID, a main EAS ID, or common EAS bundle requirements) and may receive, from the ECS, information about the EES where the EAS bundle (multiple EASs) constituting the common EAS bundle is registered. According to an embodiment, the common EAS bundle information may be included and provided in an AC profile or an application group profile. For example, when the application group profile and the common EAS bundle information are included in the request message received from the EEC, the ECS may select an EES and an EDN in which EAS which may be selected as the common EAS bundle are registered and managed using the corresponding application group profile and UE location information. The ECS may select multiple EESs and EDNs for the received common EAS bundle information. The EEC may transmit an EAS discovery request using the EES information received from the ECS as follows.

In step 1, the EEC (or first EEC) may transmit the EAS discovery request message to the announcing EES. The corresponding EAS discovery request may include at least one of the EEC ID, the UE ID, the AC profile, the application group profile (application group ID, EAS ID, expected group service area), common EAS bundle information, or UE location information. In an embodiment, the corresponding EAS discovery request may include common EAS bundle information. The common EAS bundle information may include at least one of the plurality of pieces of EAS information, the bundle type, the common bundle ID, the main EAS ID, common EAS bundle requirements, or the like. The common EAS bundle information may mean that the same EAS bundle as other UEs (e.g., UEs identifiable by the application group profile, a UE group IE, or a UE ID list) may be selected for the EAS bundle identified by given information.

According to an embodiment, the common EAS bundle information may be included in the AC profile, may be included in the application group profile information, or may be included in the EAS bundle requirement, and the corresponding EAS discovery request may be provided to the announcing EES. For example, as shown in the following table, it may be added to the application group profile, and the EEC may provide the information to the announcing EES. Further, as shown in Table 1 provided in FIG. 2, common EAS bundle-related information may be included in the EAS bundle requirement and be provided to the announcing EES.

In step 2, the announcing EES performs an authorization operation for the EAS discovery request of the EEC. It may be identified whether common EAS bundle discovery and selection is allowed for the corresponding UE or EEC.

In step 3, the announcing EES, after performing successful authorization, may determine the common EAS bundle considering the AC profile, UE location, common EAS bundle information, and EAS profile (information received from the EAS) and may provide the corresponding information to the EEC through an EAS discovery response message. The information about the common EAS bundle determined by the announcing EES and provided to the EEC may include at least one of a plurality of EAS profile lists (each EAS profile includes EAS address information), information indicating that the corresponding EAS are a bundle, an EAS bundle requirement, or main EAS information about the selected common EAS bundle.

In step 4A, the announcing EES may select an announce target EES (receiving EES) considering the common EAS bundle information and the EDN information. For example, the EES may select an EES disposed in the same EDN and transmit the common EAS bundle information or may determine to transmit the common EAS bundle information to an EES in a specific area.

In step 4b, the announcing EES may transmit the corresponding common EAS bundle information notification message to the selected surrounding EES (receiving EES) to perform the common EAS bundle announcement operation. In an embodiment, the information provided by the announcing EES to another EES (receiving EES) may include at least one of EAS ID, EAS address information, a common bundle ID, a common bundle type, a UE group ID, a UE ID list, an application group profile, and EES information in which the EASs constituting the common EAS bundle are registered (the EES in which the main EAS is registered may be indicated as the main EES, and may include address and identifier information about the main EES) and EDN information (DNAI or DNN information). Further, the information provided to the other EES (receiving EES) by the announcing EES may further include common EAS bundle-related AF request information. The common EAS bundle-related AF request information may include at least one of traffic correlation indication, EAS correlation indication for UEs accessing common EAS bundle, N6 information for common EAS bundle, AF request executed indication (an indicator indicating that AF request has already been performed), and DNAI, DNN, S- or NSSAI information about the common EAS bundle.

According to an embodiment, the receiving EES may configure the announcing EES information performing the common EAS bundle information announcement as the common EAS bundle announcing EES (or EES information storing the common EAS bundle information) and store the same corresponding to the common EAS bundle information.

In step 5, the receiving EES may store the common EAS bundle-related information received from the announcing EES and provide the common EAS bundle-related information to a second EES capable of utilizing the corresponding common EAS bundle information. According to an embodiment, the receiving EES may transmit a notification of the common EAS bundle information to the EEC that has previously sent a request to subscribe to the common EAS bundle information. The second EEC may transmit a common EAS bundle information subscribe request message to the receiving EES in advance. The common EAS bundle information subscribe request message may include an EAS profile, a UE ID, EDN information, or the like. The corresponding notification message may include common EAS bundle information, a notification event ID, an EAS ID, EAS address information, a common bundle ID, a common bundle type, a UE group ID, a UE ID list, an application group profile, and EES information in which the EASs constituting the common EAS bundle are registered (the EES in which the main EAS is registered may be indicated as the main EES, and may include address and identifier information about the main EES) and EDN information, and common EAS bundle announcing EES (or EES information storing common EAS bundle information).

In step 6, the receiving EES may transmit a response message indicating that common EAS bundle information has been successfully received and stored to the announcing EES.

In an embodiment, the receiving EES receiving the common EAS bundle information notification from the announcing EES may store the corresponding information and, upon receiving a common EAS bundle discovery-related EAS discovery request from the second EEC, provide information about the EAS bundle in the common EAS bundle information to the second EEC.

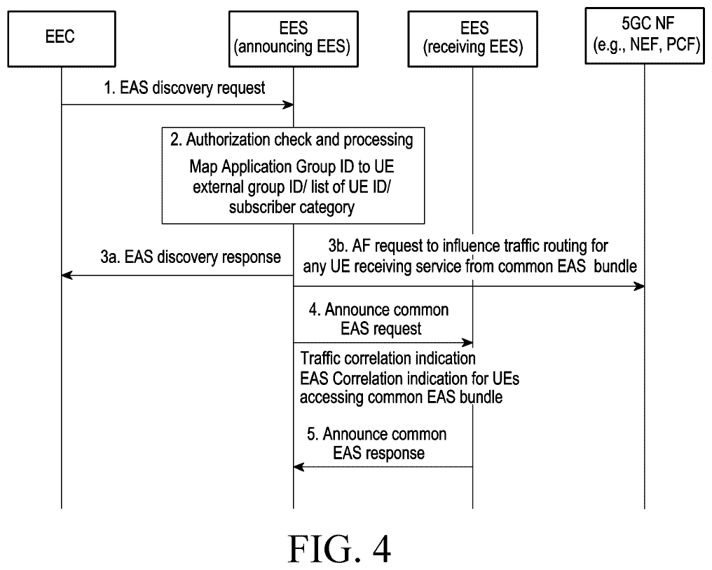

FIG. 4 illustrates an AF request procedure for a common EAS according to an embodiment of the present disclosure.

Referring to FIG. 4, an AF request procedure for a common EAS bundle may be performed between an EEC, an announcing EES, an ECS, a receiving EES, a 5GC network function (NF) (e.g., network exposure function (NEF) or policy control function (PCF)), and in the disclosure, the announcing EES may be referred to as a first EES, and the receiving EES may be referred to as a second EES.

In step 1, the EEC may transmit the EAS discovery request message to the announcing EES. The corresponding EAS discovery request may include at least one of the EEC ID, the UE ID, the AC profile, the application group profile (application group ID, EAS ID, expected group service area), common EAS bundle information, or UE location information. The EAS discovery request may include common EAS bundle information. The common EAS bundle information may include the plurality of pieces of EAS information, the bundle type, the common bundle ID, the main EAS ID, common EAS bundle requirements, or the like. The common EAS bundle information may mean that the same EAS bundle as other UEs (e.g., UEs identifiable by the application group profile, a UE group IE, or a UE ID list) may be selected for the EAS bundle identified by given information.

In step 2, the announcing EES may perform an authorization operation for the EAS discovery request of the EEC. In an embodiment, the announcing EES may identify whether common EAS bundle discovery and selection is allowed for the corresponding UE or EEC.

Further, when receiving the application group ID, the announcing EES may allow the corresponding application group ID to correspond to information such as the UE external group ID or a UE internal group ID, a list of UE ID, or a subscriber category or convert and store the same and may use the group ID for AF request transmission to a 5G core network network function (e.g., NEF or PCF).

In step 3a, the announcing EES, after performing successful authorization, may determine the common EAS bundle considering the AC profile, UE location, common EAS bundle information, and EAS profile (information received from the EAS) and may provide the common EAS bundle information to the EEC through an EAS discovery response message. The common EAS bundle information determined by the announcing EES and provided to the EEC may include at least one of a plurality of EAS profile lists (each EAS profile includes EAS address information), information indicating that the corresponding EAS are a bundle, an EAS bundle requirement, or main EAS information about the selected common EAS bundle.

Further, in step 3b, the announcing EES may perform AF request transmission for the common EAS bundle information to the 5G core network network function (e.g., NEF or PCF). The AF request for the common EAS bundle information may include at least one of the UE external group ID or a UE internal group ID, a list of UE ID, or a subscriber category converted in step 2 and determine a target UE range and may additionally include, e.g., traffic correlation indication or EAS correlation indication to indicate that it is a request for the common EAS bundle. Further, the corresponding AF request may include at least one of the common EAS bundle information (EAS address, DNN, S-NSSAI, DNAI, and N6 routing information). In an embodiment, step 3b may be performed before step 3a.

In step 4, the announcing EES may select another EES (receiving EES) and perform a common EAS bundle information announcement. The operation in which the announcing EES selects the receiving EES may include the operation of step 4a of FIG. 3. The common EAS bundle information announcement message may include the information described in connection with step 4b of FIG. 3. According to an embodiment, the announcing EES may provide the receiving EES with common EAS bundle-related subscription/notification information performed on the 5G core network network function such as notification correlation ID or subscription correlation ID as a result of performing the AF request. The corresponding subscription/notification information may be used for the receiving EES to make a modification request for the corresponding subscription. In an embodiment, the announcing EES may perform a common EAS bundle information announcement including the traffic correlation indication, EAS correlation indication for UEs accessing common EAS bundle to the receiving EES.

In step 5, the receiving EES may transmit the response message for step 4 to the announcing EES.

In an embodiment, the receiving EES, when receiving an indicator indicating that the AF request for the common EAS bundle has been performed from the announcing EES, may not perform an additional AF request in duplicate.

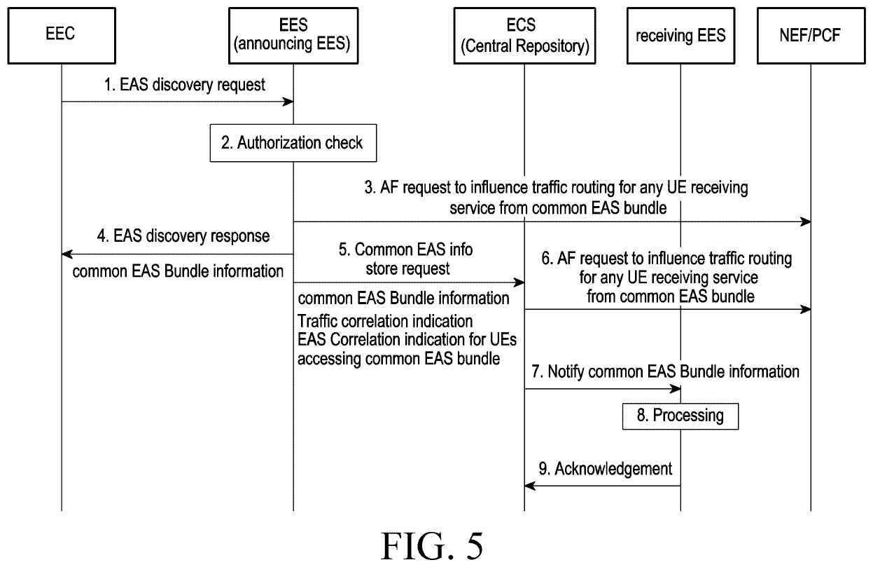

FIG. 5 illustrates an AF request procedure for a common EAS according to an embodiment of the present disclosure.

Referring to FIG. 5, an AF request procedure for a common EAS bundle may be performed between an EEC, an announcing EES, an ECS, a receiving EES, a 5GC network function (NF) (e.g., network exposure function (NEF) or policy control function (PCF)), and in the disclosure, the announcing EES may be referred to as a first EES, and the receiving EES may be referred to as a second EES.

In steps 1 and 2, the EEC and the announcing EES may perform the operations of steps 1 and 2 of FIG. 2.

In step 3, the announcing EES may perform AF request transmission for the common EAS bundle information to the 5G core network network function (e.g., NEF or PCF). The AF request for the common EAS bundle information may include the UE external group ID or a UE internal group ID, a list of UE ID, or a subscriber category converted in step 2 and determine a target UE range and may additionally include, e.g., a traffic correlation indication or an EAS correlation indication to indicate that it is a request for the common EAS bundle. Further, the corresponding AF request may include the common EAS bundle information (EAS address, DNN, S-NSSAI, DNAI, and N6 routing information).

In step 4, the announcing EES, after performing successful authorization, may provide common EAS bundle-related information to the EEC as in step 3 of FIG. 2.

In step 5, as in step 4 of FIG. 2, the announcing EES may request the ECS supporting central repository to store common EAS bundle information. According to an embodiment, the announcing EES may store AF request-related information performed in relation to the common EAS bundle, in the ECS. The common EAS bundle-related AF request information that the announcing EES may store in the ECS may include at least one of target UE range-related information such as a UE external group ID or a UE internal group ID, a list of UE ID, or a subscriber category, a traffic correlation indication, an EAS correlation indication, and the address of the EAS included in the common EAS bundle, DNN, S-NSSAI, DNAI, or N6 routing information. Further, when the announcing EES performs traffic routing-related subscription/notification on the core network due to the AF request, information that may be used to identify and modify the corresponding subscription such as a subscription correlation ID or a notification correlation ID which is related information may be provided to the ECS. Further, the announcing EES may provide an indicator indicating that the common EAS bundle-related AF request has already been performed to the ECS.

In step 6, the ECS may transmit the AF request to the core network network function (e.g., NEF or PCF) using the common EAS bundle information received from the announcing EES.

In step 7, the ECS may transmit the information received in step 5 to another EES (receiving EES) as in step 5 of FIG. 2.

In step 8, the receiving EES receiving the common EAS bundle information from the ECS may store the related information and provide the common EAS bundle-related information to a second EES capable of utilizing the corresponding common EAS bundle information. According to an embodiment, the receiving EES may transmit a notification of the common EAS bundle information to the EEC that has previously sent a request to subscribe to the common EAS bundle information. In an embodiment, when the common EAS bundle information received from the ECS includes the AF request-related information, the receiving EES may determine not to perform duplicate AF request. Further, according to an embodiment, the receiving EES may transmit the AF request to the core network network function (e.g., NEF or PCF) using the subscription ID received from the ECS to modify the AF request already performed by the announcing EES.

In step 9, the receiving EES may transmit an acknowledgment message indicating that common EAS bundle information has been successfully received and stored to the ECS.

According to the description of FIGS. 2, 3, 4, and 5, the EEC may provide the EES with information such as AC profile, application group profile (application group ID, EAS ID, expected group service area), or common EAS bundle information. The EEC may obtain such information from the AC. For example, when transmitting a message such as an AC registration request, EAS discovery request, or EEC service subscribe request through the EDGE-5 interface, the AC may include and transmit the AC profile, application group profile, and common EAS bundle to the EEC.

According to the description of FIGS. 4 and 5, it has been described that the operation of performing the AF request for the common EAS bundle on the network function of the core network is performed during the EAS discovery procedure, but the AF request for the common EAS bundle may be performed before performing the EAS discovery procedure. For example, one EAS of the EAS bundle constituting the common EAS bundle, when transmitting the EAS registration request to the EES, may include the common EAS bundle information or application group profile information in the EAS registration request message and provide the same to the EES. When receiving the EAS registration request including the common EAS bundle or application group profile information from the EAS, the EES may generate an AF request message using the corresponding information and transmit the AF request to the core network network function (e.g., NEF).

According to an embodiment, the EES may allow the application group ID included in the application group profile received from the EAS to correspond to, or convert them into, information such as a UE external group ID or a UE internal group ID, a list of UE ID, or a subscriber category in the mobile communication system and include the same in the AF request message and may include the EAS address information, EDN DNN or S-NSSAI information, common EAS-related DNAI information and N6 routing information that may be specified by the common EAS bundle information, in the AF request message.

The EES may transmit, to the core network network function (e.g., NEF), the AF request including at least one of information such as UE-related information (a UE external group ID, a list of UE ID, or a subscribe category) available in the mobile communication system, EAS address information, EDN DNN or S-NSSAI, common EAS-related DNAI information, and N6 routing information to configure traffic routing for the common EAS bundle.

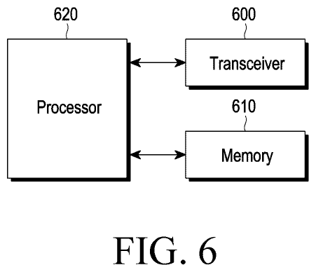

FIG. 6 illustrates a structure of a network entity according to an embodiment of the present disclosure.

The network entities shown in FIG. 6 may include network entities mentioned in the disclosure, such as an application client (AC), an edge enabler client (EEC), an edge configuration server (ECS), and an edge enabler server (EES).

According to an embodiment, the network entity may include a processor 620 controlling the overall operation of the network entity, a transceiver 600 including a transmitter and a receiver, and memory 610. Without limited thereto, the network entity may include more or less components than those shown in FIG. 6.

According to an embodiment, the transceiver 600 may transmit/receive signals to/from network entities or other network nodes. The signals transmitted/received with the network entity may include control information and data. The transceiver 600 may receive signals via a radio channel, output the signals to the processor 620, and transmit signals output from the processor 620 via a radio channel.

According to an embodiment, the processor 620 may control to receive an edge application server (EAS) discovery request from a first edge enabler client (EEC), the EAS discovery request including application group profile information about a group including a user equipment (UE) of the first EEC and first common EAS bundle information, determine a common EAS bundle for the group including the UE of the first EEC based on the application group profile information and the first common EAS bundle information, and transmit an EAS discovery response including second common EAS bundle information related to the determined common EAS bundle to the first EEC.

In an embodiment, the application group profile information may include at least one of an application group identifier (ID), an EAS ID, and an expected group service area. In an embodiment, the first common EAS bundle information may be included in one of the application group profile information or EAS bundle request information. In an embodiment, the first common EAS bundle information may include at least one of a plurality of pieces of EAS information, a common bundle type, a common bundle ID, a main EAS ID, and a common EAS bundle requirement, and the first common EAS bundle information may indicate to determine the common EAS bundle for at least one second UE determined based on the application group profile information. In an embodiment, the second common EAS bundle information may include at least one of information indicating that a plurality of EAS profile lists including address information about a plurality of EASs and the plurality of EASs are a bundle, an EAS bundle requirement, and main EAS information about a selected common EAS bundle.

According to an embodiment, the processor 620 may control to transmit an application function (AF) request for the second common EAS bundle information to a network entity included in the core network. In an embodiment, the AF request may include at least one of a UE external group identifier (ID), a UE internal group ID, a list of UE ID, a subscriber category, a traffic correlation indication, and an EAS correlation indication.

According to an embodiment, the processor 620 may control to request an edge configuration server (ECS) to store the second common EAS bundle information. In an embodiment, the second common EAS bundle information may be transmitted to a second EES receiving a common EAS discovery request from a second EEC related to a group including a first UE of the first EEC.

According to an embodiment, the processor 620 may determine a third EES to be notified of the common EAS bundle information based on the common EAS bundle information and edge data network (EDN) information. The processor 620 may notify the third EES of the common EAS bundle information.

The methods according to the embodiments described in the specification or claims of the disclosure may be implemented in hardware, software, or a combination of hardware and software.

When implemented in software, there may be provided a computer readable storage medium storing one or more programs (software modules). One or more programs stored in the computer readable storage medium are configured to be executed by one or more processors in an electronic device. One or more programs include instructions that enable the electronic device to execute methods according to the embodiments described in the specification or claims of the disclosure.

The programs (software modules or software) may be stored in random access memories, non-volatile memories including flash memories, read-only memories (ROMs), electrically erasable programmable read-only memories (EEPROMs), magnetic disc storage devices, compact-disc ROMs, digital versatile discs (DVDs), or other types of optical storage devices, or magnetic cassettes. Or the programs may be stored in memory constituted of a combination of all or some thereof. As each constituting memory, multiple ones may be included.

The programs may be stored in attachable storage devices that may be accessed via a communication network, such as the Internet, Intranet, local area network (LAN), wide area network (WAN), or storage area network (SAN) or a communication network configured of a combination thereof. The storage device may connect to the device that performs embodiment via an external port. A separate storage device over the communication network may be connected to the device that performs embodiment.

In the above-described specific embodiments, the components included in the disclosure are represented in singular or plural forms depending on specific embodiments provided. However, the singular or plural forms are selected to be adequate for contexts suggested for ease of description, and the disclosure is not limited to singular or plural components. As used herein, the singular forms “a,” “an,” and “the” are intended to include the plural forms as well, unless the context clearly indicates otherwise.

Although specific embodiments have been described above, various changes may be made thereto without departing from the scope of the disclosure. Thus, the scope of the disclosure should not be limited to the above-described embodiments and should rather be defined by the following claims and equivalents thereof.

Although the present disclosure has been described with various embodiments, various changes and modifications may be suggested to one skilled in the art. It is intended that the present disclosure encompass such changes and modifications as fall within the scope of the appended claims.

What is claimed is:

1. A method by an edge enabler server (EES) in a mobile edge computing system, the method comprising:
transmitting, to an edge configuration server (ECS), a request message for storing common edge application server (EAS) bundle information,
wherein the request message includes the common EAS bundle information, and
wherein the common EAS bundle information includes at least one of EAS bundle identifier (ID) of an EAS bundle, a list of EAS ID in the EAS bundle and main EAS ID in the EAS bundle.

2. The method of claim 1, wherein the common EAS bundle information includes at least one of EAS bundle type of the EAS bundle, and
wherein the request message includes at least one of at least one EES ID related to the EAS bundle and edge data network (EDN) information.

3. The method of claim 1, wherein the ECS supports repository function and the EES is registered in the ECS supporting the repository function, and
wherein the common EAS bundle information is stored in the ECS.

4. The method of claim 1, further comprising:
receiving, from a first edge enabler client (EEC), an EAS discovery request, the EAS discovery request including first common EAS bundle information;
determining a common EAS bundle for a group including a user equipment (UE) of the first EEC based on the first common EAS bundle information; and
transmitting, to the first EEC, an EAS discovery response including second common EAS bundle information related to the determined common EAS bundle.

5. The method of claim 1, further comprising:
transmitting, to a network entity included in a core network, an application function (AF) request for the common EAS bundle information,
wherein the AF request includes at least one of a UE external group ID, a UE internal group ID, a list of UE IDs, a subscriber category, a traffic correlation indication, or an EAS correlation indication.

6. The method of claim 4, wherein the first common EAS bundle information includes at least one of a plurality of pieces of EAS information, common bundle type information, a common bundle ID, a main EAS ID, or at least one common EAS bundle requirement.

7. The method of claim 1, wherein the common EAS bundle information is transmitted to a second EES receiving a common EAS discovery request from a second EEC related to a group including a first UE of the first EEC.

8. A method by an edge configuration server (ECS) in a mobile edge computing system, the method comprising:
receiving, from an edge enabler server (EES), a request message for storing common edge application server (EAS) bundle information; and
storing the common EAS bundle information,
wherein the request message includes the common EAS bundle information, and
wherein the common EAS bundle information includes at least one of EAS bundle identifier (ID) of an EAS bundle, a list of EAS ID in the EAS bundle and main EAS ID in the EAS bundle.

9. The method of claim 8, wherein the common EAS bundle information includes at least one of EAS bundle type of the EAS bundle, and
wherein the request message includes at least one of at least one EES ID related to the EAS bundle and edge data network (EDN) information.

10. The method of claim 8, wherein the ECS supports repository function and the EES is registered in the ECS supporting the repository function.

11. An edge enabler server (EES) in a mobile edge computing system, the EES comprising:
a transceiver; and
at least one processor coupled to the transceiver and configured to:
transmit, to an edge configuration server (ECS), a request message for storing common edge application server (EAS) bundle information,
wherein the request message includes the common EAS bundle information, and
wherein the common EAS bundle information includes at least one of EAS bundle identifier (ID) of an EAS bundle, a list of EAS ID in the EAS bundle and main EAS ID in the EAS bundle.

12. The EES of claim 11, wherein the common EAS bundle information includes at least one of EAS bundle type of the EAS bundle, and
wherein the request message includes at least one of at least one EES ID related to the EAS bundle and edge data network (EDN) information.

13. The EES of claim 11, wherein the ECS supports repository function and the EES is registered in the ECS supporting the repository function, and
wherein the common EAS bundle information is stored in the ECS.

14. The EES of claim 11, wherein the at least one processor is further configured to:
receive, from a first edge enabler client (EEC), an EAS discovery request, the EAS discovery request including first common EAS bundle information,
determine a common EAS bundle for a group including a user equipment (UE) of the first EEC based on the first common EAS bundle information, and
transmit, to the first EEC, an EAS discovery response including second common EAS bundle information related to the determined common EAS bundle.

15. The EES of claim 11, wherein the at least one processor is further configured to:
transmit, to a network entity included in a core network, an application function (AF) request for the common EAS bundle information,
wherein the AF request includes at least one of a UE external group ID, a UE internal group ID, a list of UE IDs, a subscriber category, a traffic correlation indication, or an EAS correlation indication.

16. The EES of claim 14, wherein the first common EAS bundle information includes at least one of a plurality of pieces of EAS information, common bundle type information, a common bundle ID, a main EAS ID, or at least one common EAS bundle requirement.

17. The EES of claim 11, wherein the common EAS bundle information is transmitted to a second EES receiving a common EAS discovery request from a second EEC related to a group including a first UE of the first EEC.

18. An edge configuration server (ECS) in a mobile edge computing system, the ECS comprising:
a transceiver; and
at least one processor coupled to the transceiver and configured to:
receive, from a first edge enabler server (EES), a request message for storing common edge application server (EAS) bundle information, and
store the common EAS bundle information,
wherein the request message includes the common EAS bundle information, and
wherein the common EAS bundle information includes at least one of EAS bundle identifier (ID) of an EAS bundle, a list of EAS ID in the EAS bundle and main EAS ID in the EAS bundle.

19. The ECS of claim 18, wherein the common EAS bundle information includes at least one of EAS bundle type of the EAS bundle, and
wherein the request message includes at least one of at least one EES ID related to the EAS bundle and edge data network (EDN) information.

20. The ECS of claim 18, wherein the ECS supports repository function and the EES is registered in the ECS supporting the repository function.
